(19) United States
(12) Patent Application Publication
(10) Pub. No.: US 2008/0251307 A1
(43) Pub. Date: Oct. 16, 2008

(54) Speed Limiting for a Light-Weight Utility Vehicle

(75) Inventor: Oliver A. Bell, Aiken, SC (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/735,122

(22) Filed: Apr. 13, 2007

(51) Int. Cl. B60T 8/00

(52) U.S. Cl. 180/170

(57) ABSTRACT

A method of limiting speed of a light-weight utility vehicle is provided. The method includes receiving a terrain roughness signal generated from a motion sensor. The signal indicates a roughness of a terrain over which the utility vehicle is traversing. The method additionally includes determining a peak-to-peak amplitude of the terrain roughness signal and limiting the speed of the utility vehicle if the peak-to-peak amplitude is greater than a maximum threshold.

### FIELD

The present teachings relate to limiting the speed of a vehicle in accordance with terrain operating conditions.

### BACKGROUND

The statements in this section merely provide background information related to the present disclosure and may not constitute prior art.

It is common for operators of electric golf cars and utility vehicles to drive these vehicles into areas of rough terrain. For example, an operator of a golf car may choose to follow his errant tee shot into the woods or rough. Traveling in areas of rough terrain at high speeds causes damage to the vehicle suspension, chassis, and can be uncomfortable or even dangerous for passengers.

Conventional methods of preventing such damage rely on golf car operators to recognize rough terrain conditions and reduce vehicle speed accordingly. If and when an operator determines the terrain is too rough for the existing speed, the operator may not react in sufficient time to prevent adverse consequences. Automatically detecting rough terrain conditions and limiting vehicle speed during vehicle travel through such terrains will help to protect vehicle components and passengers.

### SUMMARY

Accordingly, a method for limiting the speed of a light-weight utility vehicle is provided. The method includes receiving a terrain roughness signal generated from a motion sensor. The terrain roughness signal is representative of a roughness of a terrain over which the utility vehicle is traversing. The method additionally includes determining a peak-to-peak amplitude of the terrain roughness signal and limiting speed of the vehicle if the peak-to-peak amplitude is greater than a maximum threshold.

In other features, a system for limiting the speed of a light-weight utility vehicle while driving on rough terrain is provided. The system includes a motion sensor mounted to a suspension member of the utility vehicle. The motion sensor generates a terrain roughness signal that varies in accordance with a deflection of the suspension member. A controller receives the terrain roughness signal, determines a peak-to-peak amplitude of the terrain roughness signal and controls the speed of a vehicle motor based on the amplitude.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present teachings in any way.

FIG. 1 is a block diagram illustrating an exemplary vehicle including a terrain monitoring and motor control system, in accordance with various embodiments.

FIG. 2 is a side view of a front wheel suspension, knuckle and hub assembly of the exemplary vehicle shown of FIG. 1 including a motion sensor of the terrain monitoring and motor control system, in accordance with various embodiments.

FIG. 3 illustrates an exemplary terrain roughness signal generated by the motion sensor mounted to the front wheel suspension, knuckle and hub assembly shown in FIG. 2, in accordance with various embodiments.

FIG. 4 is a flowchart illustrating a speed limiting application of the terrain monitoring and motor control system of FIG. 1, in accordance with various embodiments.

FIG. 5 is a flowchart illustrating a speed limiting application of the terrain monitoring and motor control system of FIG. 1, in accordance with various other embodiments.

FIG. 6 is a flowchart illustrating a speed limiting application of the terrain monitoring and motor control system of FIG. 1, in accordance with yet various other embodiments.

### DETAILED DESCRIPTION

The following description is merely exemplary in nature and is in no way intended to limit the present disclosure, application, or uses. For purposes of clarity, like reference numbers will be used in the drawings to identify like elements.

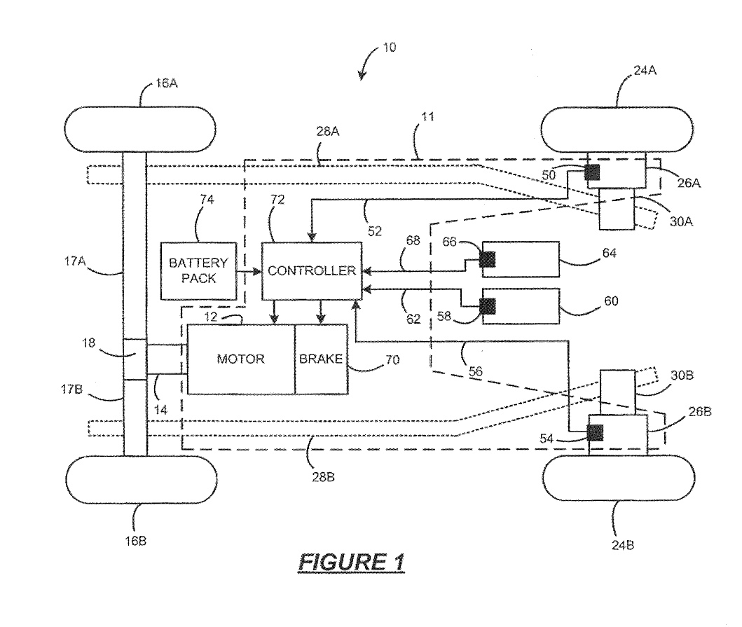

FIG. 1 is a block diagram illustrating components of a non-limiting, exemplary vehicle 10, including a terrain monitoring and motor control system 11, in accordance with various embodiments. As can be appreciated, vehicle 10 can be any vehicle type including but not limited to, gasoline, electric, and hybrid. The vehicle 10 includes a motor 12 that is operatively coupled to a drive shaft 14 operatively coupled to rear axles 17A and 17B, via a differential 18. The vehicle 10 additionally includes a pair of rear wheels 16A and 16B that are operatively coupled to the rear axles 17A and 17B such that the motor 12 drives, i.e., provides torque to, the rear wheels 16A and 16B via the drive shaft 14, differential 18 and axles 17A and 17B. The motor 12 can be any known motor, and/or motor generator technology, including, but not limited to, gas powered engines or motors, AC induction machines, DC machines, synchronous machines, and switched reluctance machines. The vehicle 10 further includes a pair of front wheels 24A and 24B operatively coupled to a respective pair of wheel knuckle and hub assemblies 26A and 26B that allow the front wheels 24A and 24B to rotate and laterally pivot. The wheel knuckle and hub assemblies 26A and 26B are operatively mounted to a pair of respective suspension arms 30A and 30B that operatively connect to respective vehicle 10 frame members 28A and 28B.

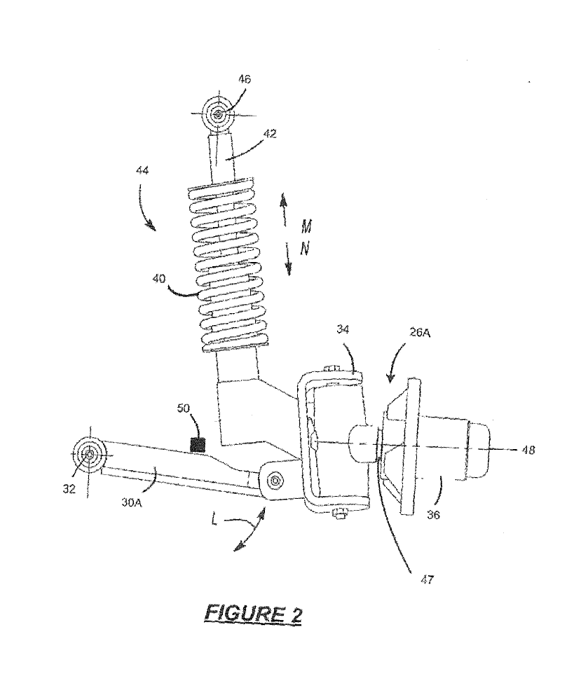

FIG. 2 illustrates an exemplary front wheel suspension arm 30A and knuckle and hub assembly 26A, in accordance with various embodiments. The suspension arm 30A is rotatably supported by a pin 32 to frame 28A (shown in FIG. 1) to permit a steering knuckle 34 and a wheel hub 36 to pivot at a distal end of suspension arm 30A, as illustrated by a wheel deflection arc ‘L’. A spring/shock absorber assembly 44 couples to knuckle 34 and includes a coil 40 and a shock absorber 47. Coil 40 and shock absorber 42 deflect to allow motion of spring/shock absorber assembly 44 in each of a compression direction ‘M’ and an expansion direction ‘N’. Shock absorber 42 can be fixedly connected at mounting pin 46 to a support structure (not shown) of vehicle 10. Front wheel 24A is fixedly mounted to wheel hub 36 which rotatably mounts to a shaft 47 along hub rotation axis 48. A motion sensor 50 mounts to suspension arm 30A and detects movement or deflection of arm 30A along deflection arc ‘L’. Motion sensor 50 can be any known sensing device in the art including, but not limited to, a Hall-effect transducer and a strain gage.

Referring now to FIGS. 1 2, and 3, motion sensor 50 generates a terrain roughness signal 52 that varies in accordance with the movement of suspension arm 30A along arc ‘L’. As can be appreciated, suspension arm 30B and front wheel knuckle and hub assembly 26B can be a mirror image of suspension arm 30A and front wheel knuckle and hub assembly 26A. Thus, a motion sensor 54, coupled to the suspension arm 30B also generates a terrain roughness signal 56 which varies in accordance with the movement of suspension arm 30B along arc ‘L’.

The vehicle 10 includes an accelerator assembly that includes an accelerator position sensor 58 and an accelerator pedal 60. Accelerator position sensor 58 generates an accelerator signal 62 based on a sensed position of accelerator pedal 60. The vehicle 10 also includes a brake pedal assembly that includes a brake pedal 64 and a brake position sensor 66. Brake position sensor 66 generates a brake signal 68, based on a sensed position of brake pedal 64, that controls the operation of a brake 70 coupled to motor 12. More particularly, a controller 72 receives the brake signal 68 and generates control signals to brake 70 to vary the braking force applied to motor 12.

Additionally, in accordance with various embodiments, the controller 72 controls voltage, current, and/or power provided to motor 12 from a battery pack 74 based on various signal inputs, such as accelerator signal 62 and/or terrain roughness signals 52 and 56. The battery pack 74 can include any known battery technology, including but not limited to lead acid, lithium ion, and lithium polymer batteries.

As can be appreciated, controller 72 may be any known microprocessor, controller, or combination thereof known in the art. In various embodiments, controller 72 includes a microprocessor having read only memory (ROM), random access memory (RAM), and a central processing unit (CPU). Microprocessor may include any number of software control modules that provide the functionality for speed limiting of vehicle 10. In various other embodiments, controller 72 is an application specific integrated circuit (ASIC), an electronic circuit, a combinational logic circuit and/or other suitable components that provide the speed limiting functionality.

As can be appreciated, the functionality of controller 72 may be partitioned into one or more controllers (not shown). For example, a controller (not shown) containing a microprocessor may be located external to controller 72. The external controller may process accelerator signal 62 and brake signal 68 and controller 72 may control motor 12 and brake 70 based on processed signals received from the external controller.

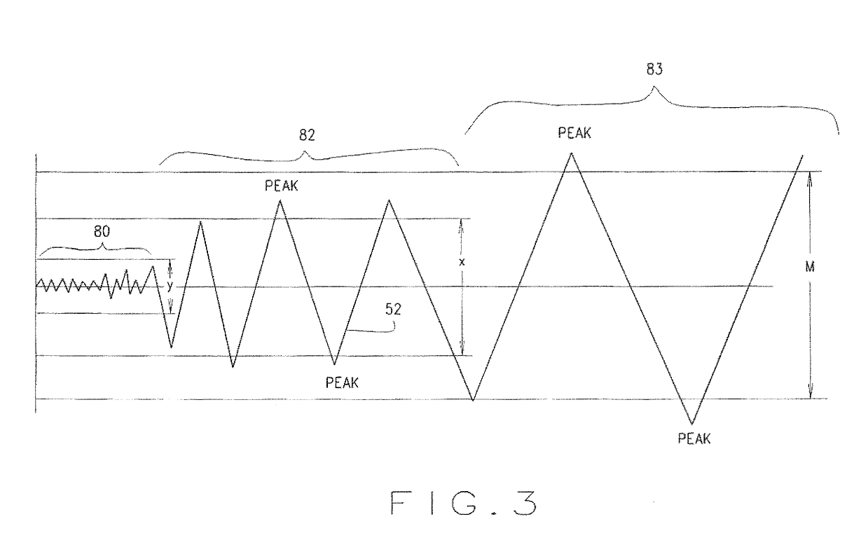

FIG. 3 illustrates an exemplary terrain roughness signal 52 or 56 generated from motion sensor 50 or 54, in accordance with various embodiments. It should be understood that motions sensor 50 and 54 operate in substantially identical manners with regard to the respective suspension arms and knuckle and hub assemblies 30A/26A and 30B/26B. Accordingly, for simplicity and clarity, the operation of motion sensors 50 and 54 will be described and illustrated in FIGS. 3 through 6 with respect to only motion sensor 50 and suspension arm and knuckle and hub assembly 30A/26A. Motion sensor 50 generates terrain roughness signal 52 that varies in accordance with the deflection of suspension arm 30A along arc ‘L’. As the terrain becomes rough, the peak-to-peak amplitude of terrain roughness signal 52 becomes greater. An exemplary terrain roughness signal 52 generated from the vehicle 10 traversing a generally smooth terrain, where suspension arm 30A deflection is small, is shown generally at 80. As the roughness of the terrain traversed by the vehicle 10 increases, the peak-to-peak amplitude of roughness signal 52 will also increase. Similarly, as the terrain roughness decreases, e.g., smooths out, the peak-to-peak amplitude of roughness signal 52 will decrease or smooth out. An exemplary terrain roughness signal 52 generated from the vehicle 10 traversing a substantially rough terrain, where the deflection of suspension arm 30A is significantly greater when traversing a generally smooth terrain, is shown generally at 82. Once the peak-to-peak amplitude of the terrain roughness signal 52 exceeds a selectable threshold X, controller 72 generates output signals to motor 12 to limit the speed of vehicle 10.

In various embodiments, as shown generally at 83, if the peak-to-peak amplitude of terrain roughness signal 52 exceeds a second selectable threshold M, indicating a severe change in terrain roughness, controller 72 applies brake 70 to limit the speed of vehicle 10. Once a smooth terrain is detected, controller 72 adjusts vehicle speed to the speed indicated by accelerator pedal 60 via motor 12. It will be understood, that various embodiments may provide for vehicle 10 speed control only by controlling either motor 12 speed or braking force or in the opposite order as described above.

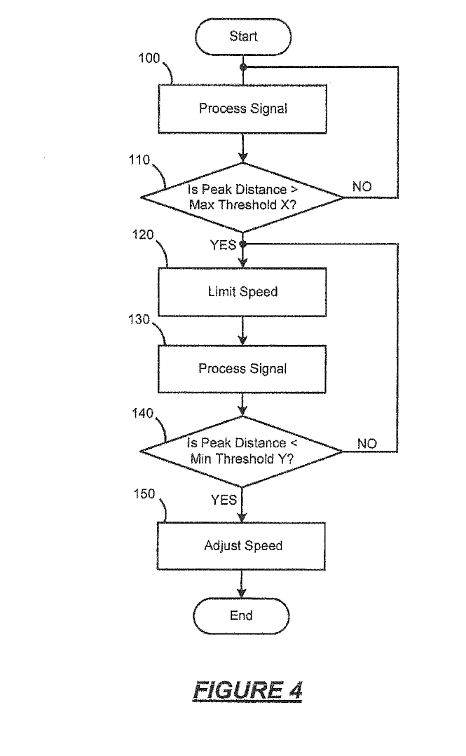

FIG. 4 is a flowchart illustrating the operation of the terrain monitoring and motor control system 11 based on the sensed terrain that vehicle 10 is traversing, in accordance with various embodiments. As the vehicle 10 traverses the terrain, the suspension arm 30A will move back and forth, i.e., up and down, along arc L in correlation to the roughness of the terrain. Simultaneously, the motion sensor 50, mounted to the suspension arm 30A, will move back and forth along arc L in correlation to the roughness of the terrain being traversed. As described above, the motion sensor 50 generates the terrain roughness signal 52 that is indicative of the terrain roughness.

The roughness signal 52 is communicated to and processed by the controller 72 to monitor the peak-to-peak amplitude of the terrain roughness signal 52, at 100. By way of non-limiting example, terrain roughness signal 52 is processed. As can be appreciated, various embodiments can limit speed based on processing one or more terrain roughness signals, for example terrain roughness signals 52 and 56 can be substantially simultaneously processed. If the peak-to-peak amplitude between of terrain roughness signal 52 is greater than a maximum threshold X, as illustrated at 110, the speed of vehicle 10 is limited, as illustrated at 120. The maximum threshold X can be any predetermined value based on attributes of at least one of arm 30A and motion sensor 50 such as, the position of the motion sensor 50, the length of the suspension arm 30A and/or motion and sensor resolution. If the peak-to-peak amplitude of terrain roughness signal 52 is less than the maximum threshold X, the terrain roughness signal 52 is continually monitored, as illustrated at 100.

In various other embodiments, the terrain roughness signal 52 generated from motion sensor 50 can be filtered in order to determine an average of peak-to-peak amplitudes value over a selected time period. Averaging the peak-to-peak values of terrain roughness signal 52 over a selected time period filters errors due to noise in the terrain roughness signal 52. Accordingly, if the average of the peak-to-peak amplitudes is greater than a maximum threshold X, the speed of vehicle 10 is limited, as illustrated at 120. The maximum threshold X can be a selectable value based on attributes of at least one of the suspension arm 30A and the motion sensor 50, as discussed above.

After limiting the speed of vehicle 10, as illustrated at 120, the terrain roughness signal 52 continues to be processed to determine a subsequent peak-to-peak amplitudes of terrain roughness signal 52, as illustrated at 130. If the peak-to-peak amplitude is subsequent less than a minimum threshold Y (shown in FIG. 3), as illustrated at 140, the speed of vehicle 10 is adjusted back to a desired speed that is indicated by accelerator signal 62, as illustrated at 150.

Adjustments to the speed of vehicle 10, as controlled by the terrain monitoring and motor control system 11, can be made at a predetermined rate to effect a smooth speed adjustment. If the peak-to-peak amplitude is greater than or equal to the minimum threshold Y, as indicated at 140, the speed of vehicle 10 is continually limited, as indicated at 120, until the peak-to-peak amplitude is below the minimum threshold Y, indicating that the terrain being traversed by the vehicle 10 is generally smooth.

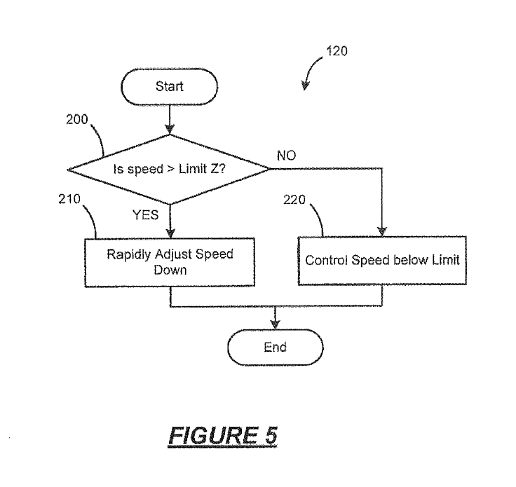

FIG. 5 is a flowchart illustrating the operation of the terrain monitoring and motor control system 11 based on the sensed terrain that vehicle 10 is traversing, in accordance with various other embodiments. If the speed of vehicle 10 exceeds a selectable limit Z, as illustrated at 200, the controller 72 adjusts the voltage, current, and/or power provided to motor 12 such that the speed of vehicle 10 is rapidly reduced to or below the limit Z, as illustrated at 210. If the speed vehicle 10 is less than the selectable limit Z, as illustrated at 200, the controller 72 maintains the voltage, current, and/or power provided to the motor 12, such that the speed of vehicle 10 remains at or below the selectable limit Z, as indicated at 220. The selectable limit Z can be determined based on a constant value for all levels, or severity, of terrain roughness, or can vary based on a value of the peak-to-peak amplitude of the terrain roughness signal 52, indicating the roughness of the terrain over which vehicle 10 is traversing.

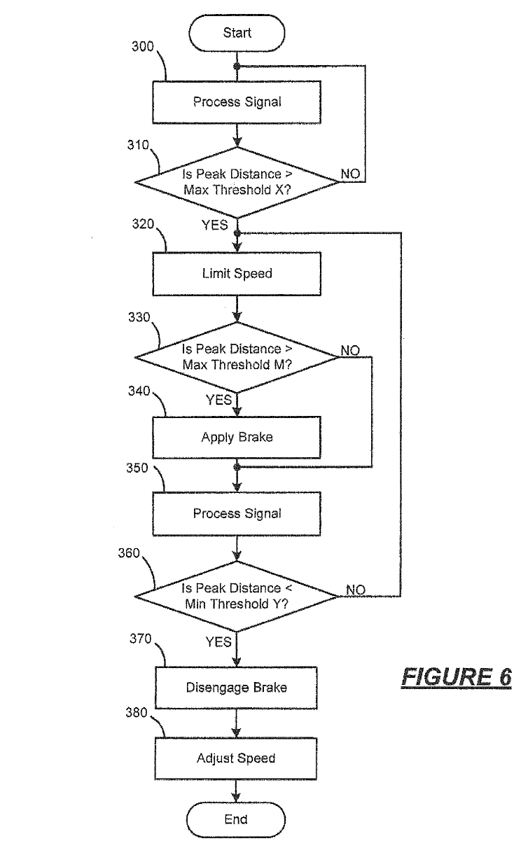

FIG. 6 is a flowchart illustrating operation of the terrain monitoring and motor control system 11 to limit the speed of the vehicle 10 by controlling motor 12 and brake 70 of vehicle 10, in accordance with yet various other embodiments. Terrain roughness signal 52 generated from motion sensor 50 is processed to determine the peak-to-peak amplitude of the roughness signal 52, as illustrated at 300. By way of non-limiting example, only terrain roughness signal 52 is processed. As can be appreciated, various embodiments can limit speed based on processing one or more terrain roughness signals, for example terrain roughness signals 52 and 56 can be substantially simultaneously processed.

If the peak-to-peak amplitude of the roughness signal 52 is greater than the maximum threshold X, as illustrate at 310, the speed of vehicle 10 is limited, as illustrated at 320. As described above, the maximum threshold X can be a selectable value based on attributes of at least one of the suspension arm 30A and the motion sensor 50. The speed of vehicle 10 can be limited, as illustrated at 320, by controlling voltage, current, and/or power provided to motor 12 such that the speed of vehicle 10 is not greater than a selectable limit. In various embodiments, the operations shown in FIG. 5 can be implemented similarly to limit the speed of vehicle 10, as illustrated at 320. If the peak-to-peak amplitude is less than or equal to the maximum threshold X, as illustrated at 310, terrain roughness signal 52 continues to be processed, as illustrated at 300.

In various other embodiments, the terrain roughness signal 52 generated from motion sensor 50 can be processed by the controller 72 in order to determine an average of peak-to-peak amplitude values for a selected time period. Averaging the peak-to-peak values of terrain roughness signal 52 over a selected time period filters error due to noise in terrain roughness signal 52. If the average of the peak-to-peak amplitude values is greater than the maximum threshold X, the speed of vehicle 10 is limited, as illustrated at 120. As described above, the maximum threshold X can be a selectable value based on attributes of at least one of the suspension arm 30A and the motion sensor 50.

With further reference to FIG. 6, if the peak-to-peak amplitude of the terrain roughness signal 52 is greater than a second maximum threshold M, as illustrated at 330, the brake 70 can be commanded to an apply state, as illustrated at 340. After limiting the speed and applying brake 70, the controller 72 continues to monitor the terrain roughness signal 52 in order to determine subsequent peak-to-peak amplitudes of the terrain roughness signal 52, as illustrated at 350. If subsequent peak-to-peak amplitudes is less than the minimum threshold Y, as illustrated at 360, the brake 70 is commanded to a disengaged state, as illustrated at 370, and the speed of vehicle 10 is adjusted back to a desired speed indicated by accelerator signal 62, as illustrated at 380.

If the peak-to-peak amplitude of the terrain roughness signal 52 is greater than the minimum threshold Y, as illustrated at 360, the speed of vehicle 10 is limited, as illustrated at 320. The speed of vehicle 10 is limited and/or brake 70 is applied until the peak-to-peak amplitude of the roughness signal 52 is below the minimum threshold Y, indicating that the terrain being traversed by the vehicle 10 is generally smooth. Adjustments to the speed of vehicle 10, as controlled by the terrain monitoring and motor control system 11, can be made at a predetermined rate to effect a smooth speed adjustment.

As can be appreciated, all comparisons made in various embodiments of FIGS. 4, 5, and 6 can be implemented in various other forms depending on the selected values for the peak-to-peak thresholds and the speed limit. For example, a comparison of “greater than” may be equivalently implemented as “greater than or equal to” in various embodiments. Or a comparison of “less than” may be equivalently implemented “as less than or equal to” in various embodiments.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A method of limiting speed of a light-weight utility vehicle, comprising:
receiving a terrain roughness signal generated from a motion sensor, the signal indicating a roughness of a terrain over which the utility vehicle is traversing;
determining a peak-to-peak amplitude of the terrain roughness signal; and
limiting speed of the utility vehicle if the peak-to-peak amplitude is greater than a maximum threshold.

2. The method of claim 1, the receiving the terrain roughness signal comprising receiving the terrain roughness signal generated from the motion sensor mounted to a suspension member of the vehicle.

3. The method of claim 2, the maximum threshold is based on attributes of at least one of the suspension member and the motion sensor.

4. The method of claim 1, the limiting speed of the vehicle comprising limiting speed of the vehicle if the peak-to-peak amplitude is equal to the maximum threshold.

5. The method of claim 1, the determining the peak-to-peak amplitude comprising determining an average of a plurality of peak-to-peak amplitude values of the terrain roughness signal for a selected time period and the limiting speed of the vehicle comprising limiting speed of the utility vehicle if the average of the plurality of peak-to-peak amplitude values is at least one of greater than and equal to the maximum threshold.

6. The method of claim 1, further comprising:
determining a second peak-to-peak amplitude of the terrain roughness signal; and
adjusting the speed of the utility vehicle if the second peak-to-peak amplitude is less than a minimum threshold.

7. The method of claim 1, further comprising determining an average of a plurality of peak-to-peak amplitudes of the terrain roughness signal for a selected time period and adjusting the speed of the utility vehicle if the average of the plurality of peak-to-peak amplitudes is less than the minimum threshold.

8. The method of claim 6, further comprising receiving an accelerator signal from an accelerator position sensor mounted to an accelerator pedal and the adjusting the speed of the utility vehicle comprising adjusting the speed of the utility vehicle to a speed indicated by the accelerator signal.

9. The method of claim 6, the adjusting the vehicle speed is performed at a slower rate than the limiting the vehicle speed.

10. The method of claim 1, the limiting the speed of the utility vehicle, comprising:
determining a current vehicle speed;
adjusting vehicle speed down if the current vehicle speed is greater than a limit; and
controlling vehicle speed below the limit if the current vehicle speed is less than the limit.

11. The method of claim 11, the limit is a variable value based on a severity of roughness of the terrain.

12. The method of claim 1, further comprising applying a brake if the peak-to-peak amplitude is at least one of greater than and equal to a second maximum threshold.

13. The method of claim 12, further comprising:
determining a second peak-to-peak amplitude between peaks of the terrain roughness signal; and
disengaging the brake and adjusting the speed of the utility vehicle if the second peak-to-peak amplitude is less than a minimum threshold.

14. The method of claim 15, further comprising receiving an accelerator signal from an accelerator position sensor mounted to an accelerator pedal and the adjusting the speed of the utility vehicle comprising adjusting the speed of the utility vehicle to a speed indicated by the accelerator signal.

15. A system for limiting speed of a light-weight utility vehicle while driving on rough terrain, comprising:
a motion sensor mounted to a suspension member of the vehicle and that generates a terrain roughness signal that varies in accordance with a deflection of the suspension member;
a motor that supplies power to propel the utility vehicle; and
a controller that receives the terrain roughness signal, determines a peak-to-peak amplitude of the terrain roughness signal, and controls a speed of the motor based on the peak-to-peak amplitude.

16. The system of claim 15, wherein if the peak-to-peak amplitude is at least one of greater than and equal to a maximum threshold, the controller limits the speed of the motor.

17. The system of claim 16, the maximum threshold is based on attributes of at least one of the motion sensor and the suspension member.

18. The system of claim 15, the controller configured to determine an average of peak-to-peak amplitudes of the terrain roughness signal within a time period and limit the speed of the motor if the peak-to-peak average is at least one of greater than and equal to a maximum threshold.

19. The system of claim 15, the controller configured to control the speed of the motor by adjusting the speed down to a limit if a current speed is greater than the limit.

20. The system of claim 15, the controller configured to control the speed of the motor by controlling the speed of the motor such that the speed of the motor remains below a limit if a current speed is already below the limit.

21. The system of claim 15, further comprising a brake, and the controller configured to apply the brake if the peak-to-peak amplitude is at least one of greater than and equal to a second maximum threshold.

22. The system of claim 15, the controller configured to determine a second peak-to-peak amplitude of the terrain roughness signal generated from the motion sensor and to adjust the speed of the motor back to a desired vehicle speed if the second peak-to-peak amplitude is at least one of less than and equal to a minimum threshold.

23. The system of claim 22, the desired vehicle speed is based on an accelerator position signal.

24. The system of claim 21, the controller configured to determine a second peak-to-peak amplitude between peaks of the terrain roughness signal generated from the motion sensor, and to disengage the brake and adjust the speed of the motor back to a desired vehicle speed if the second peak-to-peak amplitude is at least one of less than and equal to a minimum threshold.

25. A light-weight utility vehicle, comprising:
a motion sensor mounted to a suspension member of the vehicle and that generates a terrain roughness signal that varies in accordance with a deflection of the suspension member;
a motor that supplies power to propel the utility vehicle; and
a controller that receives the terrain roughness signal, determines a peak-to-peak amplitude of the terrain roughness signal, and controls a speed of the motor based on the amplitude.
